(19) United States
(12) Patent Application Publication
(10) Pub. No.: US 2006/0162488 A1
(43) Pub. Date: Jul. 27, 2006

(54) Bicycle pedal assembly

(76) Inventor: Chung-I Chen, Taichung Hsien (TW)

Correspondence Address: CHRISTIE, PARKER & HALE, LLP, PO BOX 7068, PASADENA, CA, 91109-7068, US

(21) Appl. No.: 11/029,090

(22) Filed: Jan. 4, 2005

(51) Int. Cl. G05G 1/14

(52) U.S. Cl. 74/594.6

(57) ABSTRACT

A bicycle pedal assembly includes a pedal unit and a cleat that is adapted to be connected fixedly to a shoe. The pedal unit includes a pedal body, and a pair of front and rear retaining members. The cleat includes an insert block confined between front and rear retaining members and spaced apart from the pedal body, and a pedal-engaging block connected removably to the insert block and abutting against the pedal body. The pedal-engaging block is made of a material that is softer than the pedal body.

### BACKGROUND OF THE INVENTION

1. Field of the Invention

This invention relates to a bicycle pedal, and more particularly to a bicycle pedal assembly that includes a cleat and that connects a shoe to a crank.

2. Description of the Related Art

Referring to FIG. 1, a conventional bicycle pedal assembly connects a shoe 10 to a crank 11, and includes a cleat 12 and a pedal unit 13. The cleat 12 is connected fixedly to a bottom surface 101 of the shoe 10. The pedal unit 13 includes a pedal shaft 14, a pedal body 15 sleeved rotatably on the pedal shaft 14, and a pair of front and rear retaining members 16, 17. During use, the cleat 12 is placed on the pedal unit 13, and is then pressed downwardly until it contacts the pedal body 15. The cleat 12 can be rotated on the pedal body 15 to disconnect from the same. Due to frequent connection and disconnection of the cleat 12 onto and from the pedal unit 13, the pedal body 15 is apt to wear at a portion thereof contacting the cleat 12. The service life of the pedal unit 13 is therefore reduced.

### SUMMARY OF THE INVENTION

The object of this invention is to provide a bicycle pedal assembly that includes a pedal unit, which has a long service life.

According to this invention, a bicycle pedal assembly includes a pedal unit and a cleat that is adapted to be connected fixedly to a shoe. The pedal unit includes a pedal body, and a pair of front and rear retaining members. The cleat includes an insert block confined between front and rear retaining members and spaced apart from the pedal body, and a pedal-engaging block connected removably to the insert block and abutting against the pedal body. The pedal-engaging block is made of a material that is softer than the pedal body. As such, when the bicycle pedal assembly is used for a long period, the element that experiences wear and therefore requires replacement is the pedal-engaging block, and not the pedal unit. The service life of the pedal unit is therefore increased.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a side view of a conventional bicycle pedal assembly, illustrating how a shoe is connected to a crank by the conventional bicycle pedal assembly;

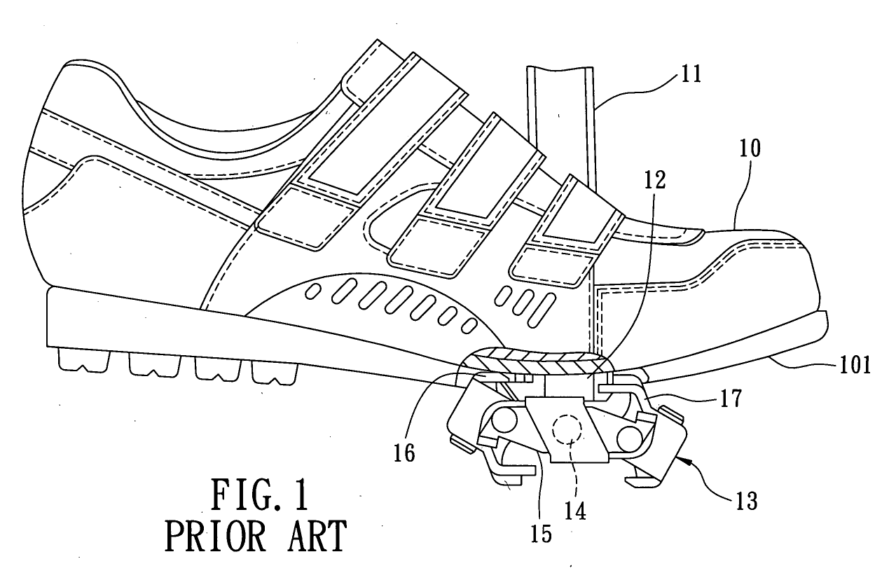

FIG. 2 is a side view of the preferred embodiment of a bicycle pedal assembly according to this invention, illustrating how a shoe is connected to a crank by the preferred embodiment;

FIG. 3 is a top view of the preferred embodiment;

FIG. 4 is a top view of the preferred embodiment, wherein a cleat is removed from a pedal unit;

FIG. 5 is a bottom view of the cleat of the preferred embodiment, wherein a pedal-engaging block is removed from an insert block;

FIG. 6 is an exploded perspective view of one of front and rear retaining members of the preferred embodiment;

FIG. 7 is a sectional view of the preferred embodiment, illustrating how two adjusting units are connected respectively to the front and rear retaining members; and

FIG. 8 is a sectional view of the preferred embodiment, illustrating how the cleat is connected fixedly to the shoe.

### DETAILED DESCRIPTION OF THE PREFERRED EMBODIMENT

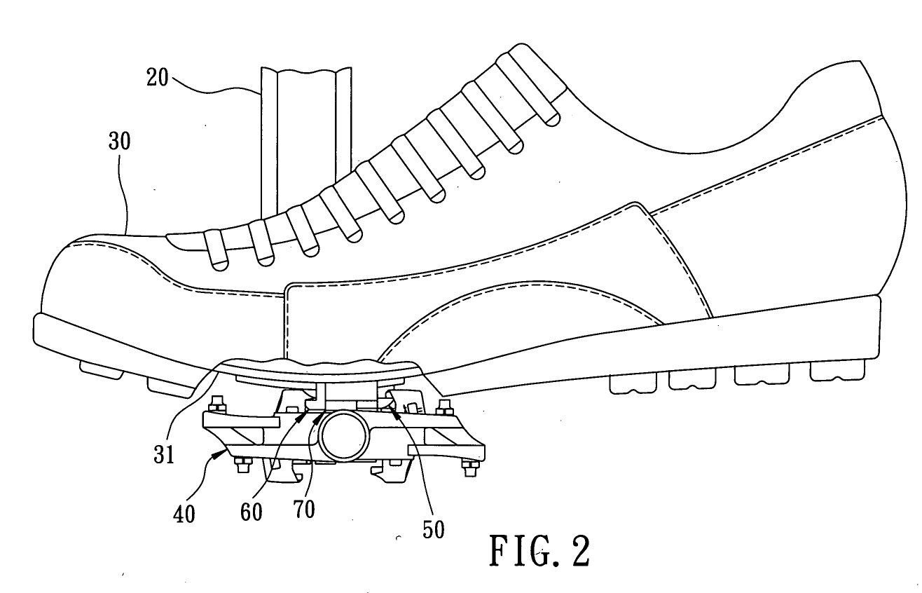

Referring to FIGS. 2, 3, and 4, the preferred embodiment of a bicycle pedal assembly according to this invention is shown to include a pedal unit 40 and a cleat 50. The pedal unit 40 is mounted to a crank 20. The cleat 50 is connected fixedly to a bottom surface 31 of a shoe 30.

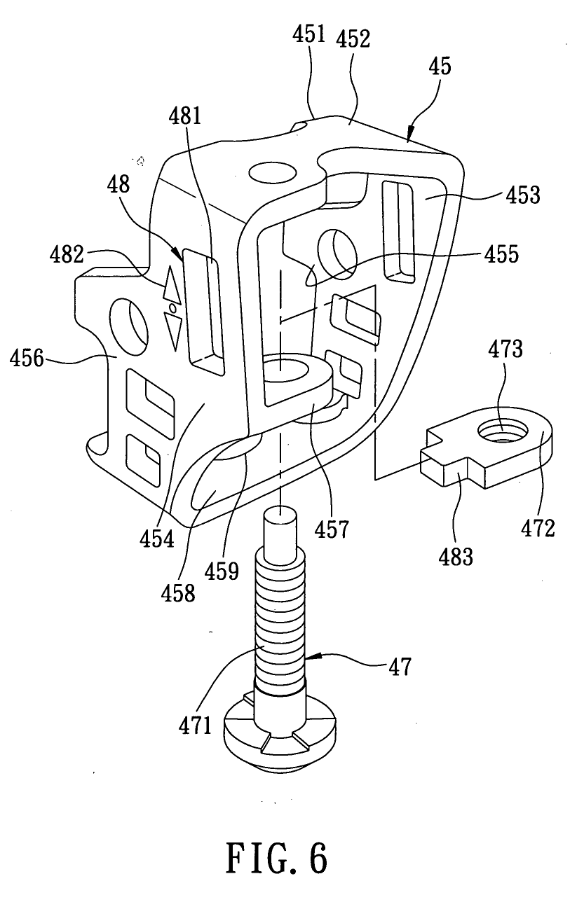

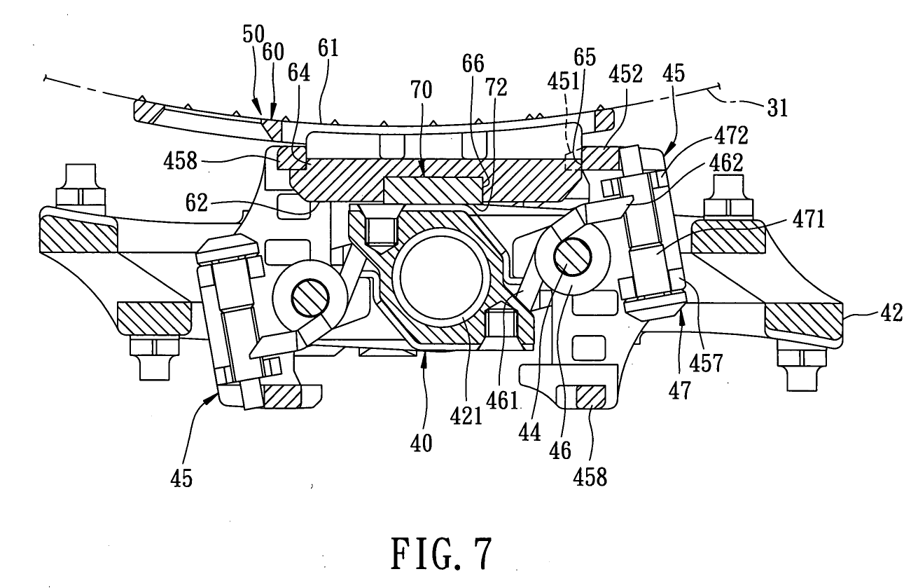

The pedal unit 40 includes a pedal shaft 41, a pedal body 42, two pivot rods 44, a pair of front and rear retaining members 45, two resilient members 46 constructed as torsional springs, two adjusting units 47 (see FIGS. 6 and 7) and two indicating units 48 (see FIG. 6).

The pedal shaft 41 is connected threadedly to the crank 20. The pedal body 42 includes an integral tube 421 sleeved rotatably on the pedal shaft 41, and an annular frame 422. Each of the front and rear pedal portions (42F, 42R) of the pedal body 42 is formed with two aligned pivot members 423, between which the corresponding pivot rod 44 is disposed. The annular frame 422 and the pivot members 423 are connected fixedly to the tube 421. The front and rear retaining members 45 are mounted respectively and rotatably on the front and rear pedal portions (42F, 42R) of the pedal body 42 by the pivot rods 44. The front and rear retaining members 45 are similar in construction to each other. However, the front and rear retaining members 45 are mounted with respect to each other in an inverted manner. The resilient members 46 are sleeved respectively on the pivot rods 44 so as to bias the front and rear retaining members 45 in opposite directions.

Because the front and rear retaining members 45 are similar in construction to each other, only the front retaining member 45 will be described in the succeeding paragraph.

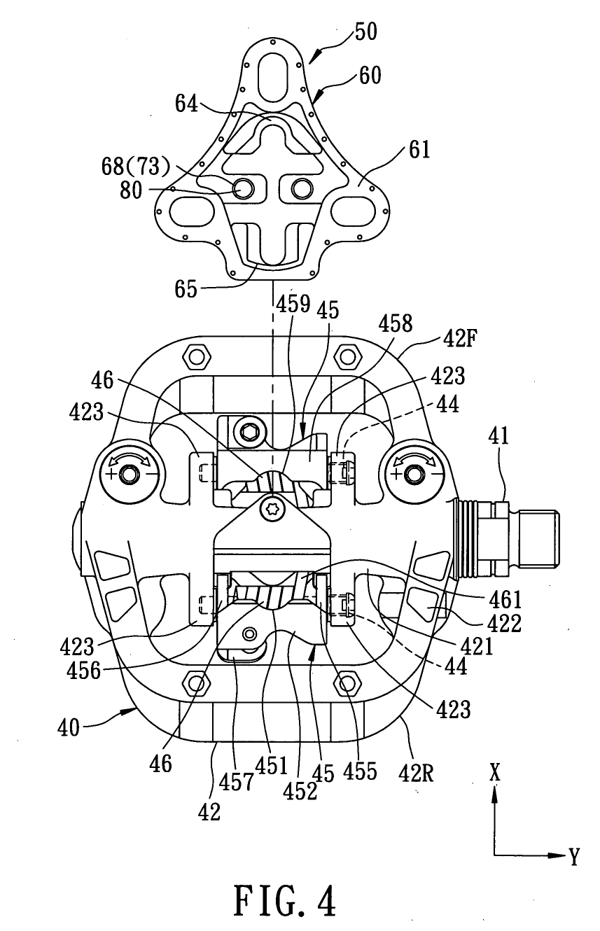

Referring to FIGS. 4, 6 and 7, the front retaining member 45 includes a clamping wall 451 with a clamping portion 452, a first sidewall 453, a second sidewall 454, a first pivot block 455, a second pivot block 456, a fixed block 457, and a confining wall 458 with a confining portion 459. The first and second sidewalls 453, 454 are disposed rotatably between the pivot members 423 by the corresponding pivot rod 44. The first and second pivot blocks 455, 456 are formed respectively and integrally with the first and second sidewalls 453, 454. The corresponding pivot rod 44 extends through the first and second pivot blocks 455, 456. The clamping wall 451 and the confining wall 458 are disposed between and formed integrally with the first and second sidewalls 453, 454, and are opposite to each other. The fixed block 457 extends integrally from the second sidewall 454 toward the first sidewall 453.

Each of the resilient members 46 has a first end leg 461 abutting against the pedal body 42, and a second end leg 462.

The adjusting units 47 are operable to adjust respectively the biasing forces of the resilient members 46 toward the front and rear retaining members 45. Each of the adjusting units 47 interconnects a respective one of the front and rear retaining members 45 and a respective one of the resilient members 46. Because the adjusting units 47 are similar in construction to each other, only one thereof will be described in the succeeding paragraph.

The adjusting unit 47 includes an adjustment bolt 471 and an adjusting block 472. The adjusting block 472 is disposed between the corresponding clamping wall 451 and the corresponding fixed block 457, and has a threaded hole 473 formed therethrough. The adjustment bolt 471 extends through the corresponding clamping wall 451 and the corresponding fixed block 457, and engages the threaded hole 473 in the adjusting block 472. The second end leg 462 of the corresponding resilient member 46 abuts against the adjusting block 472. The adjustment bolt 471 can be rotated relative to the corresponding fixed block 457 so as to move the adjusting block 472 between the corresponding clamping wall 451 and the corresponding fixed block 457, thereby varying the biasing force of the corresponding resilient member 46.

Each of the indicating units 48 indicates the magnitude of the biasing force of the corresponding resilient member 46. Each of the indicating units 48 includes a slide slot 481 formed through the corresponding second sidewall 454, a scale unit 482 indicated on the corresponding second sidewall 454 and disposed in proximity to the slide slot 481, and an indicating element 483 extending integrally from the corresponding adjusting block 472 and disposed slidably within the slide slot 481.

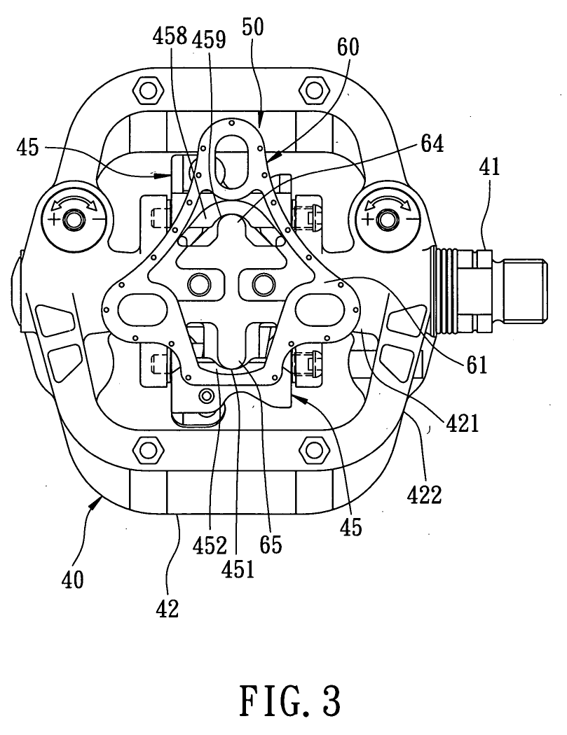

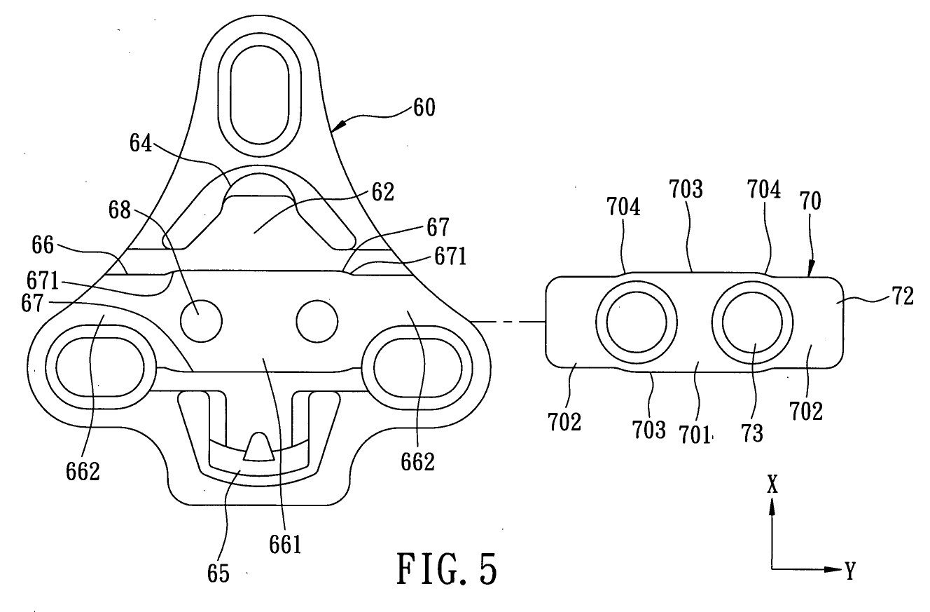

Referring to FIGS. 3, 4 and 5, the cleat 50 includes an insert block 60 and a pedal-engaging block 70. The insert block 60 is spaced apart from the pedal body 42, and has a first side surface 61, a second side surface 62, a front insert portion 64, a rear insert portion 65, an accommodating groove 66 and two through holes 68. The first side surface 61 is connected fixedly to the bottom surface 31 of the shoe 30. The second side surface 62 is opposite to the first side surface 61, and faces the pedal body 42. The front insert portion 64 is inserted into a space between the confining portion 459 of the confining wall 458 of the front confining member 45 and the pedal body 42. The rear insert portion 65 is opposite to the front insert portion 64 along a first direction (X), and is clamped between the clamping portion 452 of the clamping wall 451 of the rear retaining member 45 and the pedal body 42. The clamping portion 452 of the clamping wall 451 of the rear retaining member 45 is biased by the corresponding resilient member 46 to press the rear insert portion 65 of the insert block 60 against the pedal body 42.

Thus, the cleat 50 is confined among the pedal body 42, and the front and rear retaining members 45. The accommodating groove 66 is formed in the second side surface 62 of the insert block 60, is elongated, and extends along a second direction (Y) perpendicular to the first direction (X). The through holes 68 are formed through the insert block 60, and are in spatial communication with the accommodating groove 66. The accommodating groove 66 has a middle groove portion 661 and two opposite groove ends 662 that are narrower than the middle groove portion 661. The insert block 60 further has two wall surfaces 67 that define the accommodating groove 66 therebetween. Each of the wall surfaces 67 is formed with two shoulders 671, each of which is defined by the middle groove portion 661 and a respective one of the groove ends 662.

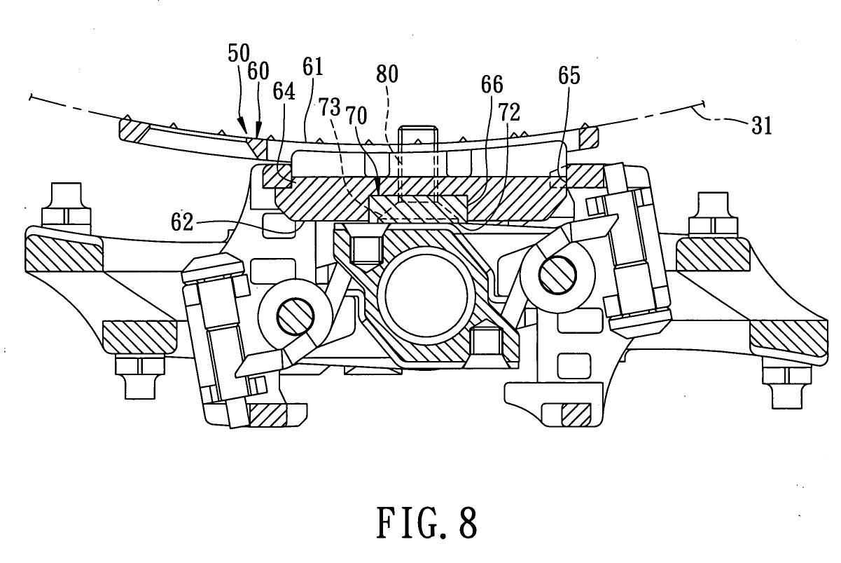

The pedal-engaging block 70 is connected removably to the insert block 60 by two lock bolts 80 (only one is shown in FIG. 8), and is received within the accommodating groove 66 in the insert block 60. The pedal-engaging block 70 has a planar bottom surface 72 abutting against the pedal body 42, and is made of a material that is softer than the pedal body 42. The pedal-engaging block 70 has a middle block portion 701 received fittingly within the middle groove portion 661 of the accommodating groove 66, and two opposite block ends 702. The block ends 702 are narrower than the middle block portion 701, and are received respectively within the groove ends 662 of the accommodating groove 66. The pedal-engaging block 70 further has two opposite side surfaces 703, and two through holes 73 formed through the pedal-engaging block 70 and aligned respectively with the through holes 68 in the insert block 60. Each of the side surfaces 703 is formed with two shoulders 704, each of which is defined by the middle block portion 701 and a respective one of the block ends 702.

During assembly, the pedal-engaging block 70 is moved into the insert block 60 in a direction perpendicular to the first and second directions (X, Y) such that the shoulders 704 of the pedal-engaging block 70 abut respectively against the shoulders 671 of the insert block 60. The pedal-engaging block 70 is therefore positioned within the accommodating groove 66 in the insert block 60. Hence, the lock bolts 80 can be inserted through the through holes 68, 73 in the pedal-engaging block 70 and the insert block 60 to engage threaded holes in the bottom surface 31 of the shoe 30, as shown in FIG. 8.

Because the pedal body 42 is harder than the pedal-engaging block 70, wear on the pedal body 42 can be prevented or reduced. As a result, the service life of the pedal unit 40 can be increased.

With this invention thus explained, it is apparent that numerous modifications and variations can be made without departing from the scope and spirit of this invention. It is therefore intended that this invention be limited only as indicated by the appended claims.

I claim:

1. A bicycle pedal assembly for connecting a shoe to a crank, said bicycle pedal assembly comprising:
a pedal unit including
a pedal shaft adapted to be connected fixedly to the crank,
a pedal body sleeved rotatably on said pedal shaft and having a front pedal portion and a rear pedal portion,
two pivot rods;
a pair of front and rear retaining members mounted respectively and rotatably on said front and rear pedal portions of said pedal body by said pivot rods, and
two resilient members sleeved respectively on said pivot rods so as to bias said front and rear retaining members to rotate in opposite directions;
a cleat including
an insert block spaced apart from said pedal body and having a first side surface adapted to be connected fixedly to the shoe, a second side surface opposite to said first side surface and facing said pedal body, a front insert portion inserted into a space between said front retaining member and said pedal body, a rear insert portion clamped between said rear retaining member and said pedal body so as to confine said cleat among said pedal body and said front and rear retaining members, and an accommodating groove formed in said second side surface, and
a pedal-engaging block connected removably to said insert block and received within said accommodating groove in said insert block, said pedal-engaging block having a planar bottom surface abutting against said pedal body of said pedal unit and being made of a material that is softer than said pedal body.

2. The bicycle pedal assembly as claimed in claim 1, wherein said front and rear insert portions of said insert block are opposite to each other along a first direction, said accommodating groove in said insert block of said cleat being elongated and extending along a second direction perpendicular to said first direction, said insert block further having two through holes formed therethrough and in spatial communication with said accommodating groove, said accommodating groove having a middle groove portion and two opposite groove ends that are narrower than said middle groove portion, said insert block further having two wall surfaces that define said accommodating groove therebetween, each of said wall surfaces being formed with two shoulders, each of which is defined by said middle groove portion and a respective one of said groove ends, said pedal-engaging block having a middle block portion received fittingly within said middle groove portion of said accommodating groove in said insert block, and two opposite block ends narrower than said middle block portion and received respectively within said groove ends of said accommodating groove in said insert block, said pedal-engaging block further having two opposite side surfaces, and two through holes formed through said pedal-engaging block and aligned respectively with said through holes in said insert block, each of said side surfaces of said pedal-engaging block being formed with two shoulders, each of which is defined by said middle block portion and a respective one of said block ends, said shoulders of said pedal-engaging block abutting respectively against said shoulders of said insert block, said bicycle pedal assembly further comprising two lock bolts, each of which extends through a respective one of said through holes in said pedal-engaging block and a respective one of said through holes in said insert block, said lock bolts being adapted to be connected threadedly to the shoe.

3. The bicycle pedal assembly as claimed in claim 1, wherein each of said front and rear pedal portions of said pedal body is formed with two fixed pivot members, each of said front and rear retaining members including:
two sidewalls disposed rotatably between said pivot members by a corresponding one of said pivot rods;
a confining wall disposed between and formed integrally with said sidewalls; and
a clamping wall disposed between and formed integrally with said sidewalls and opposite to said confining wall;
said front insert portion of said insert block of said cleat being confined between said confining portion of said front retaining member and said pedal body of said pedal unit, said rear insert portion of said insert block being clamped between said clamping wall of said rear retaining member and said pedal body, said clamping wall of said rear retaining member being biased by a corresponding one of said resilient members to press said rear insert portion of said insert block against said pedal body.

4. The bicycle pedal assembly as claimed in claim 3, wherein each of said front and rear retaining members further includes a fixed block formed integrally with one of said sidewalls, said pedal unit further including two adjusting units for adjusting respectively biasing forces of said resilient members, each of said adjusting units including:
an adjusting block disposed between said clamping wall and said fixed block of a corresponding one of said front and rear retaining members and having a threaded hole formed therethrough; and
an adjustment bolt extending through said clamping wall and said fixed block of the corresponding one of said front and rear retaining members and engaging said threaded hole in said adjusting block.

5. The bicycle pedal assembly as claimed in claim 4, wherein said pedal unit further includes two indicating units, each of which indicates a magnitude of the biasing force of a corresponding one of said resilient members, each of said indicating units including:
a slide slot formed through one of said sidewalls of the corresponding one of said front and rear retaining members,
a scale unit indicated on said one of said sidewalls of the corresponding one of said front and rear retaining members and disposed in proximity to said slide slot, and
an indicating element connected fixedly to said adjusting member of a corresponding one of said adjusting units and disposed slidably within said slide slot.
